(19) United States
(12) Patent Application Publication
(10) Pub. No.: US 2018/0145555 A1
(43) Pub. Date: May 24, 2018

(54) ROTATING ELECTRIC MACHINE COMPRISING A TERMINALS BOX

(71) Applicant: MOTEURS LEROY-SOMER, Angouleme Cedex 9 (FR)

(72) Inventors: Patrick VOHLGEMUTH, Ruelle Sur Trouve (FR); Laurine DANIEL, Trelissac (FR)

(21) Appl. No.: 15/575,929

(22) PCT Filed: May 25, 2016
(86) PCT No.: PCT/EP2016/061813

§ 371 Date: Nov. 21, 2017

(30) Foreign Application Priority Data
May 26, 2015 (FR) 1554690

(51) Int. Cl. H02K 5/22; H02K 5/02

(52) U.S. Cl. CPC H02K 5/225; H02K 5/10; H02K 2213/09; H02K 5/02

(57) ABSTRACT

A rotating electrical machine, including a casing of substantially cylindrical form and a terminal box housing added to the casing, by substantially molding to the form, the housing including two parts fixed to the casing and linked to one another by at least one articulation allowing the housing to be adapted to the curvature of the casing.

The U.S. Pat. No. 5,192,888 discloses a terminal box housing comprising two parts which are assembled together with the interposition of a seal. Openings are provided for the entry of electrical conductors.

The U.S. Pat. No. 6,002,083 discloses another terminal box housing arrangement comprising two parts which are assembled together according to a substantially oblique assembly plane.

The international application WO 2011/117816 describes a terminal box housing comprising two parts, each being provided with a female part and a male part which cooperate respectively with the male and female parts of the other part, when the two parts are assembled.

The French patent application FR 2 978 629 discloses a terminal box housing comprising two parts assembled with one another and with the casing by screws, at least one of the parts comprising, on its top face, an access hatch.

The Canadian application CA 853379, the French patent FR 1 092 897, the French patent application FR 2 778 796, the Japanese applications JP 05-083899 and JP-57025133 and the U.S. Pat. No. 5,769,659 describe other examples of terminal boxes.

The housing of a great majority of the terminal boxes of industrial alternators is constructed by an assembly of multiple metal panels. The manufacture and assembling of these metal panels is tedious and requires the implementation of a large quantity of screw-fastening elements.

When the electrical machine is an alternator which is associated with a driving heat engine, to form a generator set, a control cabinet is generally provided. The electrical cabinet is positioned differently depending on the constructor, for example on top of the alternator, on one or both sides or on the rear. Whatever the position of the cabinet that is retained, access to the interior of the terminal box to perform, for example, adjustments of a voltage regulator which is present therein, has to be possible with a maximum of ease. Now, the presence of the control cabinet can hamper accessibility to the housing when an intervention on the machine is needed. Moreover, the great majority of the alternator casings are of cylindrical form. The casing diameters increase as a function of the power of the machine. Because of this, to ensure an adequate degree of protection, the interface of the housing with the casing has to be of complementary form. That means having a terminal box geometry for each casing diameter, and thus multiplying the references.

The invention aims to reduce the number of terminal box references needed to cover the different casing diameters which make up a range of alternators.

The invention also aims to simplify the production of the terminal box.

The invention even aims to make an intervention on the machine easier, so as to offer a wide diversity of possible locations of the control cabinet relative to the machine.

Thus, in order to address all or some of the abovementioned objectives, the subject of the invention is a rotating electrical machine comprising a casing and a terminal box housing added to the casing, by substantially molding to the form, the housing comprising two parts linked to one another by at least one articulation allowing the housing to be adapted to the curvature of the casing.

By virtue of the invention, the housing can be adapted to at least two different casing diameters, which makes it possible to reduce the number of references.

At least one part of the housing can occupy two different positions on the casing, namely a closed position and an open position after pivoting relative to the other part by virtue of the articulation. The latter allows each of the two parts to pivot upward from the closed position to the open position, independently of the other. That simplifies the access to the content of the terminal box, and the wiring with the control cabinet is made easier.

Each part advantageously comprises a transverse strut, the adjacent transverse struts of the parts of the housing being able to partially overlap, advantageously in a substantially seal-tight manner, as a function of the degree of relative pivoting of the parts needed to best adapt to the geometry of the casing.

The outwardly concave rounded bottom edge of at least one transverse strut is advantageously defined by a flexible lip, which contributes to allowing the strut to best mold to the form of the casing. The lip is molded directly with the part. Its profile allows it to be deformed and to mold to the different diameters on which it rests.

The articulation is preferably central, in which case the parts form half-shells. The parts of the housing are advantageously fixed to the casing independently of one another. It is thus possible to access the interior of the housing by one or the other of its sides, by pivoting the corresponding part about the articulation, without totally separating the housing from the casing.

The articulation is advantageously situated in the top part of the housing, and extends parallel to the axis of rotation of the machine.

The housing can be one-piece, being produced in a single piece, the articulation being formed for example by a flexible articulation strip produced by molding. Preferably, the form and the initial opening of the housing are such that the molding of the piece can be done according to a single mold-stripping direction. That makes it possible to limit the mold to two molding parts.

An “articulation” designates an articulated zone allowing the at least partial rotation of a part of the housing about at least one geometrical axis of rotation. The articulation can comprise a flexible strip, a bellows, or any other flexible or articulated structure allowing an adequate pivoting.

Each part of the housing can comprise:
a top wall,
two, front and rear transverse struts connected to the top wall and terminated at the bottom by an outwardly concave rounded bottom edge, preferably in the form of a circular arc, and
a lateral strut linked on one side to the top wall and on the other side to the two transverse struts.

The expression “top wall” refers to an orientation of the machine in which the latter is observed with the housing situated on the top, the axis of rotation being horizontal.

The rounded bottom edges preferably have a radius of curvature that is intermediate to those of the destination casings.

The parts are advantageously symmetrical to one another, preferably relative to a median plane containing a geometrical axis of the articulation. This plane of symmetry also, preferably, contains the axis of rotation of the machine. Inside the terminal box, on one of the sides, there is, for example, a voltage regulator, and on the other side an electrical connection block. By virtue of the symmetry of the parts, it is possible to swap the terminal block and the regulator according to the needs of the user, namely output on the left or on the right.

Each transverse strut can comprise, in proximity- to the articulation, a protuberance configured to obstruct an end of the articulation. That makes it possible to improve the protection conferred by the housing.

The housing preferably comprises, at the bottom edge of a transverse and/or lateral strut, at least one tongue for its fixing to the casing.

The top wall can comprise a central flat delimited toward the center by the articulation and toward the outside by an inclined flat extending obliquely relative to the central flat, this inclined flat being connected at the bottom to the lateral strut.

Each part, notably on the inclined flat, can have at least one removable zone, of circular outline for example, delimited by an embrittled link, that can be perforated manually, to form an opening intended to receive a conduit entry end-fitting.

Depending on the configuration of the generator sets for which the alternators are intended, two electrical connection configurations can be offered. Either the terminal block and the regulator are factory mounted in the housing and the user connects to the housing with his or her cables, or the machine is delivered not equipped with the terminal block and the regulator, but with cables ready to be connected in the power cabinet of the generator set. Usually, these two variants are produced with two different housings. However, with the inclined flats, the housing according to the invention can be suitable for ensuring these two cable exit variants. The cable exit through one of the inclined flats makes it possible not to have to use a bent conduit end-fitting, whatever the direction the conduit has to take to meet the electrical panel, on the side, at the front, at the rear, on top or otherwise.

Another subject of the invention, in combination with the above, is a range of electrical machines, comprising at least one first machine and one second machine each having casings of different diameters D₁ and D₂, with D₂>D₁, and identical terminal box housings, these housings being as defined above, with an angle formed between the parts of these housings which is different from one machine to the other.

The relative difference |D₂-D₁|/D₁ between the diameters D₁ and D₂ of the casings can lie between 0 and 50%.

The radius of curvature of the bottom edge of the transverse struts of the parts of the housing can lie between 0.8×(D₁+D₂)/4 and 1.2×(D₁+D₂)/4.

According to another of its aspects, independently of or in combination with the above, another subject of the invention is a terminal box housing having at least one inclined flat extending obliquely relative to a median plane for the housing, preferably with an angle relative to this plane of between 30″ and 60°, the inclined flat comprising one or more removable zones each delimited by an embrittled link with the rest of the inclined flat, this or these zones being preferably of circular outline, being intended to be removed manually to free an opening allowing the fitting of a cable entry end-fitting, notably equipped with a cable gland.

According to this aspect of the invention, the housing may or may not comprise two parts linked by an articulation. The advantage lies in the possibility of avoiding the use of bent end-fittings.

Preferably, the housing according to this second aspect also exhibits the features defined above, concerning the possibility of adapting to casings of different diameters.

According to yet another of its aspects, the subject of the invention, independently of or in combination with the above, is a terminal box housing for an electrical machine, comprising two parts linked by an articulation, each part preferably comprising means for fixing to the casing of the machine, notably in the form of one or more tongues fixed by screws to the casing, and at least one articulation allowing this part to pivot independently of the other to allow access to the content of the terminal box.

According to this third aspect, the housing may or may not be produced so as to adapt to different casing diameters and with or without an inclined flat as defined above.

The invention will be able to be better understood on reading the following detailed description of nonlimiting exemplary implementations thereof, and on studying the attached drawing, in which:

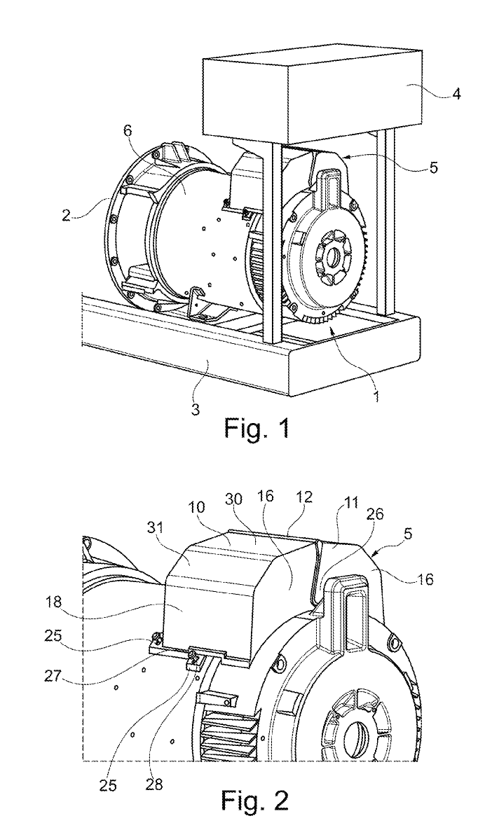

FIG. 1 represents, schematically and in perspective, an example of electrical machine equipped with a housing according to the invention,

FIG. 2 is a schematic view similar to FIG. 1 of a detail thereof,

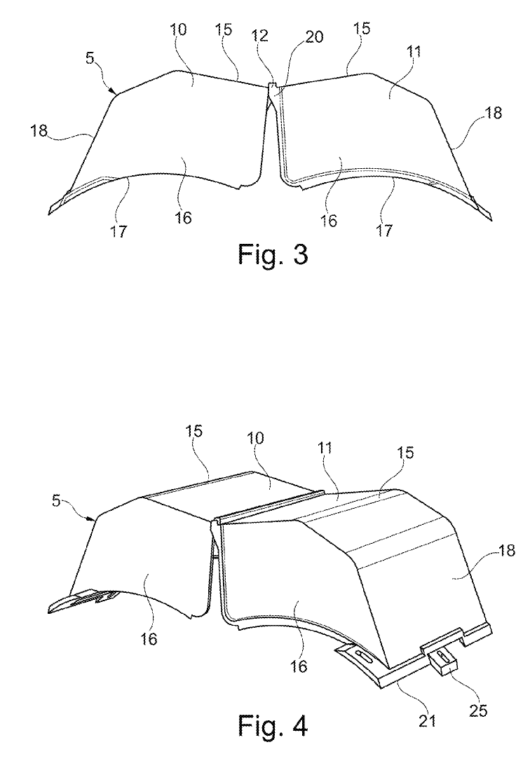

FIG. 3 represents, schematically and in isolation, in side view, the housing according to the invention, in molding configuration,

FIG. 4 is a schematic and perspective, plan view of the housing of FIG. 3,

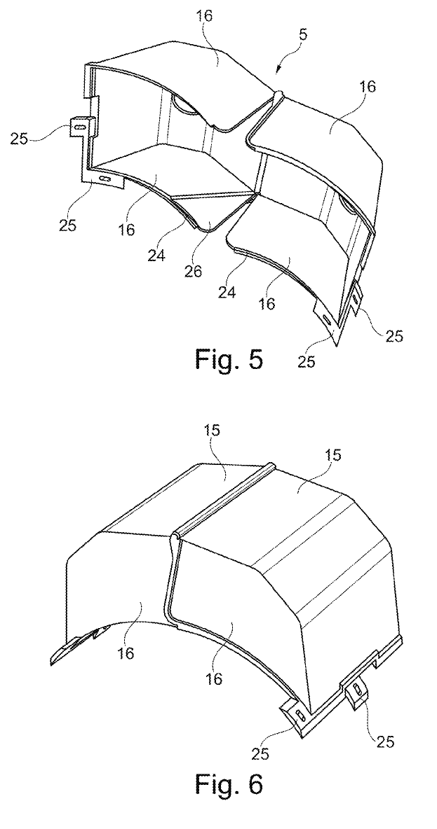

FIG. 5 is a schematic and perspective bottom view of the housing of FIG. 3,

FIG. 6 is a schematic and perspective side view of the housing of FIG. 3, ready to be put in place on the casing,

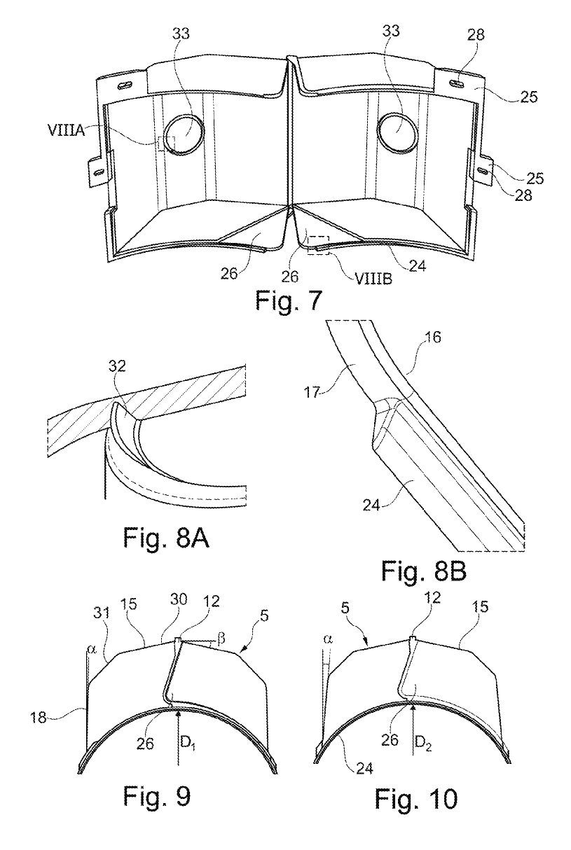

FIG. 7 is a schematic and perspective bottom view of the housing of FIG. 3,

FIG. 8A is a schematic transverse cross-sectional view of the detail VIIIA of FIG. 7,

FIG. 8B is a schematic and perspective view of the detail VIIIB of FIG. 7,

FIGS. 9 and 10 are schematic side views of the housing of FIG. 3, illustrating the possibility of the housing to adapt to casings of different diameters,

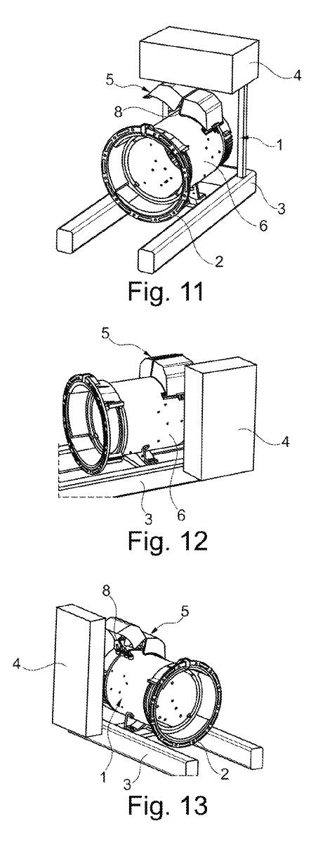

FIG. 11 is a schematic and perspective view of the machine of FIG. 1, the housing being represented partially open,

FIG. 12 illustrates, schematically and in perspective, an electrical machine with a variant layout of the control cabinet, and

FIG. 13 is a schematic and perspective view of the machine of FIG. 12, with the housing partially open.

The electrical machine 1 represented in FIGS. 1, 2 and 11 to 13, is an alternator intended to be driven in rotation by a heat engine, not represented, situated at the front of the machine. The assembly of the alternator and of the heat engine is done conventionally by a flange 2.

The alternator has been only partially represented and only the casing 6 of the machine, of substantially cylindrical form, can be seen.

The machine 1 is supported by a frame 3 to which is secured a control cabinet 4, which, depending on the generator set manufacturers, is for example positioned on the top, as illustrated in FIGS. 1 and 11, or on the side, as illustrated in FIGS. 12 and 13.

A terminal box housing 5 is provided on the top of the machine 1, fixed to the casing 6 to house, in the example illustrated, a voltage regulator 8, partially visible in FIGS. 11 and 13.

This housing 5 comprises two parts 10 and 11 linked to one another, in accordance with one aspect of the invention, by an articulation 12, consisting in this example of a flexible strip.

The two parts 10 and 11 are preferably produced in plastic material, for example in polypropylene, preferably comprising a reinforcing filler, notably mineral, for example filled to more than 15% or 20% by weight, and can initially be without any open cable entries.

At least one, and preferably each, of the parts 10 and 11, can occupy two different positions on the casing, namely a closed position and an open position, visible in FIGS. 11 and 13, after pivoting relative to the other part by virtue of the articulation 12, by an angle greater than 90° for example.

Each part 10 or 11 comprises a top wall 15, two, front and rear transverse struts 16, terminated at the bottom by a rounded bottom edge 17, notably circular, the transverse struts 16 being connected to the top wall 15. Each part 10 or 11 further comprises a lateral strut 18 linked on one side to the top wall 15 and on the other side to the two, front and rear transverse struts 16 of the part concerned.

Each transverse strut 16 comprises, in proximity to the articulation 12, a protuberance 20 positioned in the axis thereof, and thus improving the seal-tightness of the closure of the housing.

For the fixing of the parts 10 and 11 to the casing 6, the housing 5 comprises tongues 25 situated respectively at the bottom edge 17 of a transverse strut 16 or at the bottom edge 21 of the lateral strut 18. These tongues 25 comprise at least one opening 28 for the passage of a screw 27, as can be seen in FIG. 2 in particular.

The transverse struts 16 can partially overlap by an overlapping portion 26, of generally triangular form, visible in FIGS. 9 and 10, this overlap being more or less extensive depending on the degree of pivoting of the parts 10 and 11 when the housing is mounted on the casing, as a function of the diameter thereof. Thus, for a small casing diameter, the overlap will be less great than for a greater diameter. FIGS. 9 and 10 show two configurations assumed by the housing in closed position to adapt to casings of different diameters, by simple adjustment of the angle formed between the two parts. In FIG. 9, the diameter D₁ of the destination casing is less than that D₂ of the casing of FIG. 10, such that the overlap between transverse struts 16 is greater than in FIG. 10. As illustrated by dotted lines in these figures, the angle α between the lateral strut 18 and the vertical is greater in the example of FIG. 10 than that of FIG. 9.

If the radius of curvature of the rounded edge 17 of a transverse strut is R, then R=(D₁+D₂)/4 for example.

In the example illustrated, the bottom edge 17 of each transverse strut 16 is defined by a flexible lip 24 that can be seen in more detail in FIG. 8B, which further simplifies the adaptation of the housing 5 to casings of different diameters, in particular to at least two casings of different diameters. The lip 24 is produced directly by molding with the part. Its profile allows it to be deformed and to mold to the different diameters on which it rests.

The central flat 30 of the top wall 15 is slightly inclined downward relative to a horizontal axis at right angles to the median plan M for the housing, by an angle β greater than 0, in closed position of the housing 5, to avoid water stagnations on the cap, as can be seen in FIGS. 9 and 10.

Moreover, the central flat 30 is connected by an inclined flat 31 to the lateral strut 18. The inclined flat 31 forms an angle for example of between 30° and 60° relative to the median plane M.

As can be seen in FIGS. 7 and 8A, each part 10 or 11 has at least one removable zone 33 delimited by an embrittled link 32, of a thickness less than the rest of the wall as can be seen in FIG. 8A, this zone being, in this example, of circular outline. It is possible to perforate one of these zones 33 by manually breaking the embrittled link, then fitting a conduit end-fitting therein to constitute a cable entry.

To fix the housing 5 to the casing 6, fixing means such as screws 27 are introduced into the opening 28 of the tongues 25. When access to the interior of the housing 5 is required, the screws 27 are removed from the part 10 or 11 concerned, and this part 10 or 11 is pivoted upward relative to the other part, without having to separate the other part from the casing 6.

As can be seen in FIGS. 11 and 13, the content of the terminal box is accessible whatever the positioning of the control cabinet 4.

The invention is of course not limited to the examples which have just been described.

In particular, the invention applies also to a motor.

There is no departure from the scope of the invention if the system for fixing the housing to the casing is different and does not for example include tongues.

The housing can comprise more than one articulation, for example two articulations positioned laterally, the central flat being non-articulated, and the two parts being each linked to the central flat by an articulation. The housing can also comprise at least three articulations, for example a central articulation and two lateral articulations.

The overlap between the transverse struts can be replaced by a bellows.

The expression “comprising a” should be understood to be synonymous with the expression “comprising at least one”.

1. A rotating electrical machine, comprising a casing of substantially cylindrical form and a terminal box housing added to the casing, by substantially molding to the form, the housing comprising two parts fixed to the casing and linked to one another by at least one articulation allowing the housing to be adapted to the curvature of the casing.

2. The machine as claimed in claim 1, in which at least one of the parts can occupy two different positions on the casing, namely a closed position and an open position after pivoting relative to the other part by virtue of the articulation.

3. The machine as claimed in claim 1, each part comprising a transverse strut, the transverse struts being able to partially overlap more or less as a function of the degree of relative pivoting of the parts.

4. The machine as claimed in claim 3, in which the bottom edge of at least one transverse strut is defined by a flexible lip.

5. The machine as claimed in claim 1, in which the articulation is situated in the top part of the housing, and extends parallel to the axis of rotation of the machine.

6. The machine as claimed in claim 1, in which the housing is one-piece, being produced in a single piece, the articulation being formed by a flexible strip.

7. The machine as claimed in claim 1, in which each part comprises:
a top wall,
two, front and rear transverse struts connected to the top wall and terminated at the bottom by an outwardly concave rounded bottom edge, and
a lateral strut linked on one side to the top wall and on the other side to the two transverse struts.

8. The machine as claimed in claim 7, in which each transverse strut comprises, in proximity to the articulation, a protuberance configured to obstruct an end of the articulation.

9. The machine as claimed in claim 7, in which the housing comprises, at the bottom edge of at least one of a transverse strut and a lateral strut, at least one tongue for fixing the housing to the casing.

10. The machine as claimed in claim 7, in which the top wall comprises a central flat delimited toward the center by the articulation and toward the outside by an inclined flat extending obliquely relative to the central flat, this inclined flat being connected at the bottom to the lateral strut.

11. The machine as claimed in claim 1, each part having at least one removable zone delimited by an embrittled link, intended to form a cable entry after removal.

12. A range of electrical machines, comprising at least one first machine and one second machine, having casings of different diameters D₁ and D₂ with D₂ greater than D₁, and identical terminal box housings, these housings being as defined in claim 1, with an angle formed between the parts which is different from one machine to the other.

13. The range as claimed in claim 12, in which the relative difference |D₂−D₁|/D₁ between the diameters D₁ and D₂ of the casings lies between 0 and 50%.

14. The range as claimed in claim 12, in which the radius of curvature of the bottom edge of the transverse struts of the parts of the housing lies between 0.8×(D₁+D₂)/4 and 1.2×(D₁+D₂)/4.
